(19) United States
(12) Patent Application Publication
(10) Pub. No.: US 2003/0169858 A1
(43) Pub. Date: Sep. 11, 2003

(54) Method for administering and setting up services in a switched system

(75) Inventor: Joerg Boehmer, Berlin (DE)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/408,110

(22) Filed: Apr. 8, 2003

Related U.S. Application Data
(63) Continuation of application No. PCT/DE01/03904, filed on Oct. 11, 2001.

(30) Foreign Application Priority Data
Oct. 11, 2000 (DE) 10050360.8

(51) Int. Cl. H04M 1/64; H04M 11/00

(52) U.S. Cl. 379/88.01; 379/88.18

(57) ABSTRACT

The present invention relates to a system and method for administering and selecting language, dialect, vocabulary and/or sub-vocabulary for a subscriber station functionally associated with at least one switched network. In an embodiment, the switched network includes at least one subscriber station connected to a switching device which is further connected with a controller. The controller is further connected with a media gateway which facilitates communication between the switched network and/or other networks (such as the Internet). Auxiliary devices may be connected with the controller. An interactive dialog device is connected with the controller, the device enabling requests from the subscriber stations for an interactive language, dialect, vocabulary, and/or sub-vocabulary to be effected. The device and controller may communicate via an protocol such as the extended control protocol CP+. The language, dialect, vocabulary, and/or sub-vocabulary may be effected by key and/or voice inputs with the device. The device may be associated with another network, such as the Internet.

### CONTINUATION DATA

The present invention is a continuation of and claims priority to international application: PCT/DE01/03904, filed Oct. 11, 2001, and further claims priority to German patent application 10050360.8, filed Oct. 11, 2000, both of which are incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to a method for administering and setting up services in a switched system comprising, in addition to a conventional switched network to which subscriber stations are connected, at least one further switched network, particularly the Internet, the setting up of the relevant services being possible by means of key and/or voice inputs by the particular subscriber station, in Interactive dialog mode where applicable.

Services of the aforementioned type have already been implemented in large numbers in conventional switched networks. Such services include, for example, the setting up of conference connections between at least three subscriber stations, the setting up of call forwarding (all calls) or call forwarding (no answer), the setting up of barred calls lists (e.g. in respect of calling subscriber stations), automatic callback if the called subscriber station is engaged or not accessible, and announcement services, corresponding, for example, to an answering machine function. In the existing conventional switched networks, suitably configured service modules are provided for services of this type and can be activated from the particular subscriber station by means of key input and/or voice input. In the case of voice input, a form of interactive communication can sometimes also be handled with the particular subscriber station. However, this approach is regarded as unsatisfactory in a switched system comprising, in addition to a conventional switched network to which subscriber stations are connected, at least one further switched network, particularly the Internet. In this case, namely, it is desirable not only to be able to deploy the service modules available for the conventional switched network cited, said service modules usually being manufacturer-specific with regard to the switched networks, but rather general-purpose modules, called OEM modules, that are widely available on the market for voice recognition and announcement services.

An advantage of the invention is therefore to show a way how, with a method of the type cited at the beginning, service modules can be provided in a relatively simple manner outside of the switched system for the individual services to be taken into account, such that effective use can be made of them with the switched system and that, in addition, the recognition of voice inputs can be optimized.

### SUMMARY OF THE INVENTION

The above-described advantage is achieved with a method according to the invention of the type cited at the beginning in that, in order to recognize the voice inputs originating from the particular subscriber station, a specific voice recognition vocabulary is specified in an interactive dialog device or by means of such an interactive dialog device assigned to the provided further switched network, particularly the Internet, said dialog device being connected in the course of the administration of the relevant service to the particular subscriber station from which the relevant service is requested.

The invention has the advantage that in a separate dialog device assigned to said further switched network, particularly the Internet, said dialog device being composed in particular of OEM modules, the individually requested services can be administered, i.e. set up and then activated and/or deactivated, by means of an optimally recognizable voice input from the particular subscriber station. The specific characteristics of the individual services in respect of the vocabulary to be taken into account can be accommodated through the provision of a specific voice recognition vocabulary. The voice recognition vocabulary in question can be specified either by the particular subscriber station which requests a service or by means of auxiliary devices of the switching center, such as a so-called intelligent network, or by the switching center itself.

In the course of the specification of the voice recognition vocabulary, a language and where applicable a dialect is preferably specified initially. In this way it is possible, for example, to define British English as the language and the London dialect as the dialect. The recognition of voice inputs specified in respect of the language and the dialect that is possible as a result in the interactive dialog device enables an optimal interpretation of such voice inputs, something that has not been possible to date in the existing conventional switched networks. The language volume to be taken into account as a result is thus relatively limited and therefore permits recognition tailored to its specific characteristics.

Following the specification of the language and where applicable a dialect for the voice recognition vocabulary to be used for voice recognition, a sub-vocabulary is preferably defined, by means of which the complete vocabulary required for specifying the particular service is specified. The sub-vocabulary comprises, for example, a set of words to be recognized, such as all numbers from 0 through 9, the words “yes” and anon, city names in Germany, a list of names of services for the independent input by the subscriber, etc. This enables further optimization of the voice recognition function.

The call number of the individual subscriber station is advantageously used for the provision of the language and where applicable the relevant dialect. In this way the subscriber of the subscriber station in question is relieved of the effort to the extent that he/she is not required to specify or Input the language or dialect assumed for his/her subscriber station on the basis of its topological location (origin).

It is, however, useful if the language or dialect activated on the basis of the call number of the individual subscriber station can be changed into a particular desired language or desired dialect from the relevant subscriber station by means of separate voice and/or keyboard inputs. The individual subscriber will preferably make use of this measure whenever the language and also dialect initially selected for his/her voice inputs are not appropriate.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts in schematic form, a switched system according to the present invention.

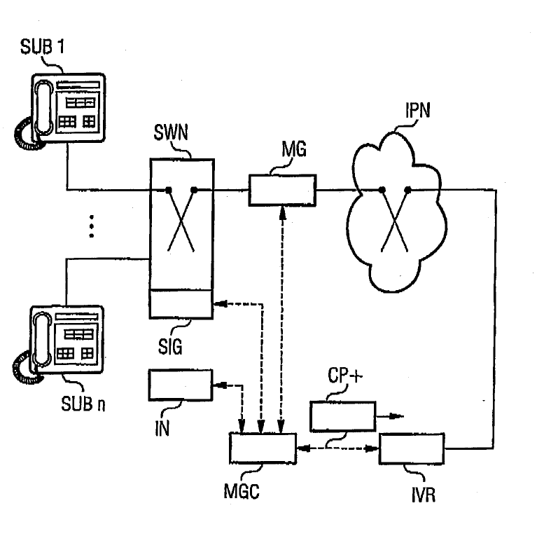

### DETAILED DESCRIPTION OF THE INVENTION

Depicted in schematic form in the drawing is a switched system comprising on the one hand a switching device SWN of a conventional switched network; this switching device SWN may be, for example, a switching device of the EWSD switching system which is in commercial use. Connected to this conventional switched network or to the switching device SWN belonging to this switched network are subscriber stations SUB1 to SUBn, which may be analog or digital subscriber stations. In addition, other terminal equipment such as fax machines and personal computers (PCs) can also be connected to the switching center in question.

The switched system cited also includes at least one further switched network, which in the present case is primarily the Internet IPN. This further switched network or Internet IPN is connected to the switching device SWN of the conventional switched network via a gateway or connecting device MG. This gateway MG is referred to here as a media gateway, since it establishes a connection between the switching device SWN to be assigned to the conventional switched world and the media world residing on the side of the Internet IPN.

Connected to the further switched network or the Internet IPN in the present case is an interactive dialog device IVR, which can be accessed and controlled by the individual subscriber stations SUB1 to SUBn in the course of the particular administration or setting up of services, and hence for the subsequent activation and/or deactivation of said services. The interactive dialog device IVR is a device which provides various dialogs for administration of the services, such as those cited above as an example, by means of key and/or voice input by individual subscriber stations. The interactive dialog device IVR in question therefore represents an interactive voice response (IVR) device.

The interactive dialog device IVR considered above may be controlled from a control device MGC, as indicated in the drawing by a dashed line. In order to fulfill the various control tasks, the control device MGC, which in the present case is a media gateway control (MGC) device, is connected both to the gateway MG as well as to a signaling device SIG of the conventional switching center SWN and, in addition, to an auxiliary device IN of the switched system. This auxiliary device IN may, for example, be an intelligent network possessing artificial intelligence, on the basis of which requests for activation or deactivation of services that are relevant to the individual subscriber stations can be submitted to the control device MGC.

With regard to the connections from and to the control device MGC as indicated by dashed lines in the drawing, it should further be remarked that the most diverse control signals conforming to different protocols can be transferred over these connections. Thus, for example, signals between the intelligent network IN and the control device MGC are transferred on the basis of the so-called INAP protocol (Intelligent Network Announcement Protocol); signals between the signaling device SIG and the control device MGC are transferred on the basis of, for example, the Signaling System No. 7. Signals between the gateway MG and the control device are transferred in accordance with the MGCP protocol (Media Gateway Control Protocol). The control device MGC as the media gateway controller/feature control is able to exchange signals with the interactive dialog device IVR in accordance with an extended control protocol, as illustrated in the drawing by the box indicated by CP+. The setting up and hence activation and deactivation of services according to the present invention is enabled by means of this extended control protocol. This will now be examined in greater detail below.

According to the invention, the recognition of voice inputs by the particular subscriber station can be optimized by the transmission of the cited extended control protocol CP+ to the interactive dialog device IVR. According to the invention, namely, a specific voice recognition vocabulary (e.g. selected from an available vocabulary set) Is thus specified in the dialog device in response to the relevant control action, thereby making it available for subsequent voice inputs by the particular subscriber station to allow optimal recognition of these voice inputs. In the process, a language and where applicable a dialect of this language is specified first (i.e. selected, for example, from an available vocabulary set of languages and dialects). This in itself already contributes to a quite considerable improvement in the recognition of voice inputs by the relevant subscriber station. In particular, the specification of the language and where appropriate the dialect allows an optimal adaptation to the individual subscriber and therefore a significantly better recognition of voice inputs than in the case where this feature is not used.

Following the specification of the language and where applicable the dialect for the voice recognition vocabulary to be used for voice recognition, a sub-vocabulary can then be usefully defined, by means of which the complete vocabulary required for specifying the particular service is specified. As indicated already at the beginning, a number of words to be recognized within the specified language and where applicable the specified dialect may be defined as a sub-vocabulary, for example: all numbers from 0 through 9, the words “yes” and “no”, city names in Germany, a list containing names of features for independent input by the subscriber, etc.

Through the specification according to the invention of a specific voice recognition vocabulary (language and where applicable dialect) and sub-vocabulary in the interactive dialog device IVR, optimal voice recognition can thus be realized for the setting up and hence the activation and/or deactivation of services in the switched system under consideration. The relevant voice recognition vocabulary can either be specified or activated by the particular subscriber station requesting a service. In this case a corresponding control action would be performed with the control device MGC via the signaling device SIG using the cited Signaling System No. 7.

However, it is also possible to make use of the call number of the individual subscriber station itself in order to provide the language and where applicable the relevant dialect. This could be realized, for example, using the intelligent network IN, which would have to submit corresponding control information to the control device MGC. In the event that the voice recognition vocabulary thus selected does not suit the particular subscriber, because, for example, it does not tally with the language or dialect spoken by the particular subscriber, the initially specified language and where applicable the relevant dialect can preferably be changed into a particular desired language and/or dialect by separate voice and/or keyboard inputs.

The aforementioned control operations between the control device MGC and the interactive dialog device IVR are executed between the different devices via the connections as represented by the dashed lines. In practice, however, this takes place only after a voice connection has been set up between the particular subscriber station and the interactive dialog device IVR, in other words after a voice connection has been set up via the switched system shown in the drawing, comprising the conventional switching device SWN and the Internet IPN connected via the gateway MG.

Upon completion of a dialog between the particular subscriber station and the interactive dialog device IVR, information about the inputs made by the relevant subscriber station is transmitted by this interactive dialog device to the control device MGC. Depending on the accessed service, and also depending on the particular subscriber input, the control device MGC can therefore specify how the individual call is to be subsequently handled. Depending on the service, the individual call can either be initiated or forwarded or incorporated in an additional dialog operating mode.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

I claim:

1. A method for administering and setting up a service for a subscriber station connected to a switched network, comprising the steps of:
connecting an interactive dialog device to said switched network and said subscriber station;
specifying a voice recognition vocabulary in said interactive dialog device from a subscriber station to be serviced in said language;
disposing an interactive dialog device in said switched network; and
communicating said specifying of said voice recognition vocabulary to said interactive dialog device.

2. The method according to claim 1, further comprising the step of connecting a signaling device to said switched network and using said signaling device to perform said step of communicating.

3. The method according to claim 1, further comprising the step of connecting an intelligent network and a media gateway control to said switched network and using said intelligent network to perform said step of communicating via said media gateway control.

4. The method according to claim 1, wherein said switched network comprises at least two switched networks, wherein one of said two switched networks is the Internet.

5. The method according to claim 4, wherein at least one of said at least two switched networks comprises at least one interactive voice recognition unit in communication with said subscriber station such that said service is selected through said at least one recognition unit.

6. The method according to claim 1, wherein said step of specifying a voice recognition vocabulary further comprises the step of specifying a language of said vocabulary.

7. The method according to claim 6, wherein said step of specifying a language further comprises the step of specifying a dialect of said language.

8. The method according to claim 6, wherein said step of specifying a language further comprises the step of defining a sub-vocabulary, said sub-vocabulary related to a desired service for said subscriber station.

9. The method according to claim 7, wherein said step of specifying a dialect further comprises the step of defining a sub-vocabulary said sub-vocabulary related to a desired service for said subscriber station.

10. The method according to claim 6, further comprising the step of providing said language based upon a call number of said subscriber station.

11. The method according to claim 7, further comprising the step of providing said dialect based upon a call number of said subscriber station.

12. The method according to claim 8, further comprising the step of providing said sub-vocabulary based upon a call number of said subscriber station.

13. The method according to claim 6, further comprising the step of selectively changing said language based upon a voice input.

14. The method according to claim 7, further comprising the step of selectively changing said dialect based upon a voice input.

15. The method according to claim 8 further comprising the step of selectively changing said sub-vocabulary based upon a key input.

16. A system for setting up and administering a service for a subscriber station connected to a switched network, comprising:
a media gateway and media gateway control for connecting said switched network to other switched networks;
a signaling device and an intelligent network connected to the media gateway and media gateway control; and
means for receiving a voice recognition vocabulary request from said subscriber system, said means associated with said other switched networks and in communication with said media gateway control.

17. The system according to claim 16, wherein said means for receiving comprises an interactive dialog device.

18. The system according to claim 16, wherein said interactive dialog device is functionally associated with said media gateway control.

19. The system according to claim 16, wherein one of said other switched networks comprises the Internet.

20. The system according to claim 16, wherein said means for receiving a voice recognition vocabulary request further comprises means for receiving a language request, said language comprising said vocabulary.

21. The system according to claim 20, wherein said means for receiving a language request further comprises means for receiving a dialect request, said dialect being associated with said language.

22. The system according to claim 21, wherein said means for receiving a language request further comprises means for receiving a sub-vocabulary request, said sub-vocabulary being associated with said vocabulary and said language.
